(19) United States
(12) Patent Application Publication
(10) Pub. No.: US 2026/0077949 A1
(43) Pub. Date: Mar. 19, 2026

(54) MULTI-AGENT REINFORCEMENT LEARNING FRAMEWORK FOR DYNAMIC DISPATCHING IN MATERIAL HANDLING SYSTEMS

(71) Applicant: HITACHI, Ltd., Tokyo (JP)

(72) Inventors: Xian Yeow LEE, Santa Clara, CA (US); Haiyan WANG, Fremont, CA (US); Daisuke KATSUMATA, Jenison, MI (US); Takaharu MATSUI, Holland, MI (US); Chetan GUPTA, San Mateo, CA (US)

(21) Appl. No.: 18/888,905

(22) Filed: Sep. 18, 2024

(51) Int. Cl. B65G 1/137; G05D 1/667; G05D 1/69; G05D 101/15; G05D 105/20; G05D 107/70

(52) U.S. Cl. CPC B65G 1/1373; G05D 1/667; G05D 1/69; G05D 2101/15; G05D 2105/20; G05D 2107/70

(57) ABSTRACT

Systems and methods for implementation of a multi-agent reinforcement learning based decision system for a materials handling system, including initializing a simulation environment comprising decision points for dispatching materials and attributes of the materials handling system, the simulation environment configured to request a decision for materials dispatch at the decision points to the multi-agent reinforcement learning based decision system; initializing the reinforcement learning agents representative of the decision points for the multi-agent reinforcement learning based decision system; initializing domain expert heuristics for the decision points for the multi-agent reinforcement learning based decision system; and iteratively training the reinforcement learning based decision system with the initialized domain expert heuristics on the simulation environment.

### BACKGROUND

### Field The present disclosure is generally directed to material handling systems, and more specifically, to multi-agent reinforcement learning frameworks for dynamic dispatching.

### Related Art

Material handling systems are integral to warehousing and logistics operations in many diverse industries, playing a pivotal role in ensuring efficient material flow. Achieving optimal performance metrics, such as maximizing throughput, minimizing congestion, etc., within these systems can have potential cascading effects on downstream applications, resulting in streamlined operations and reduced business costs.

Dynamic dispatching, a critical facet of material handling systems, involves real-time task allocation and resource management. Reinforcement Learning (RL) offers a promising avenue for enhancing dynamic dispatching, allowing algorithms to adapt and optimize decisions in real-time scenarios. Traditional dynamic dispatching algorithms are often sub-optimal when deployed in complex conveyor systems due to inherent uncertainties on both processing and demand sides in many systems, interconnection among different sub-processes leading to complex interaction between sub-processes, and limited resources that are shared among many sub-processes.

These challenges motivate the development of reinforcement learning algorithms which can potentially overcome the above-mentioned challenges. However, the training of RL algorithms requires a simulator to mimic real-world complexities so as to enable the development and testing of algorithms, as it is often cost-prohibitive and infeasible to train RL algorithms in actual systems.

In the related art, the existing methods mainly rely on domain or subject matter experts to understand the system and to manually develop rule-based heuristics to optimize the dynamic dispatching problem. Additionally, there has been some related art implementations on the general idea of using RL for dynamic dispatching in job scheduling for computer systems as well as for optimizing dynamic dispatching using non-RL based algorithms for dynamic dispatching in material handling systems.

For example, for related art implementations not related to RL for dynamic dispatching, there are related art implementations that perform dynamic dispatching using mixed-integer programming for lean manufacturing systems as well as dynamic truck routing between automated facilities. In related art implementations that use RL for dynamic dispatching, there have been related art implementations for job shop scheduling, which is a closely related, but a different problem than dynamic dispatching for material handling systems.

### SUMMARY

Example implementations described herein are directed to developing a framework to train event-based multi-agent RL (MARL) algorithms to improve the Key Performance Indicators (KPIs) of the material handling system, such as the system's throughputs and to developing a Python-based simulator for material handling systems with integrated generic processes as a platform to develop RL/Heuristic algorithms for dynamic dispatching and is easily customizable to specific layouts and operations.

In a first problem with the related art, the hand-crafted dynamic dispatching logic often results in sub-optimal throughputs as material handling systems are often subjected to inherent uncertainties in upstream and downstream processes. Additionally, even when the manually developed logic is optimal, hard-coded logic does not have the capability to generalize and are often fine-tuned according to the characteristics of the material handling system, hence requiring major re-development when the characteristic of the material handling system changes.

In another problem with the related art, there is a necessity for subject matter experts to deeply understand the system to manually develop a logic in actual systems due to complex, interconnected relationships between all subprocesses in a material handling system, hence it often requires a lot of time.

In another problem with the related art, it can be challenging for conventional RL algorithms to scale to systems with arbitrary decision points and to explore a large decision space to learn an optimal logic.

In another problem with the related art, it can be challenging to develop RL/Heuristic algorithms with black-box off-the-shelf simulators and expensive and inefficient to develop them on the actual system.

Aspects of the present disclosure can involve a method for implementation of a multi-agent reinforcement learning based decision system for a materials handling system, the method involving initializing a simulation environment comprising decision points for dispatching materials and attributes of the materials handling system, the simulation environment configured to request a decision for materials dispatch at the decision points to the multi-agent reinforcement learning based decision system; initializing the reinforcement learning agents representative of the decision points for the multi-agent reinforcement learning based decision system; initializing domain expert heuristics for the decision points for the multi-agent reinforcement learning based decision system; and iteratively training the reinforcement learning based decision system with the initialized domain expert heuristics on the simulation environment.

Aspects of the present disclosure can involve a computer program having instructions for implementation of a multi-agent reinforcement learning based decision system for a materials handling system, the instructions involving initializing a simulation environment comprising decision points for dispatching materials and attributes of the materials handling system, the simulation environment configured to request a decision for materials dispatch at the decision points to the multi-agent reinforcement learning based decision system; initializing the reinforcement learning agents representative of the decision points for the multi-agent reinforcement learning based decision system; initializing domain expert heuristics for the decision points for the multi-agent reinforcement learning based decision system; and iteratively training the reinforcement learning based decision system with the initialized domain expert heuristics on the simulation environment. The computer program and instructions can be stored on a non-transitory computer readable medium and executed by one or more processors.

Aspects of the present disclosure can involve a system for implementation of a multi-agent reinforcement learning based decision system for a materials handling system, the system involving means for initializing a simulation environment comprising decision points for dispatching materials and attributes of the materials handling system, the simulation environment configured to request a decision for materials dispatch at the decision points to the multi-agent reinforcement learning based decision system; means for initializing the reinforcement learning agents representative of the decision points for the multi-agent reinforcement learning based decision system; means for initializing domain expert heuristics for the decision points for the multi-agent reinforcement learning based decision system; and means for iteratively training the reinforcement learning based decision system with the initialized domain expert heuristics on the simulation environment.

Aspects of the present disclosure can involve an apparatus for implementation of a multi-agent reinforcement learning based decision system for a materials handling system, the apparatus involving a processor, configured to initialize a simulation environment comprising decision points for dispatching materials and attributes of the materials handling system, the simulation environment configured to request a decision for materials dispatch at the decision points to the multi-agent reinforcement learning based decision system; initialize the reinforcement learning agents representative of the decision points for the multi-agent reinforcement learning based decision system; initialize domain expert heuristics for the decision points for the multi-agent reinforcement learning based decision system; and iteratively train the reinforcement learning based decision system with the initialized domain expert heuristics on the simulation environment.

In an aspect, there is a component involving the training of event-based multi-agent RL systems with domain knowledge incorporation. Example implementations can involve, (i) initializing RL-based agents at decision points in conveyor system with appropriate state space and decision space and a RL-based critic agent, (ii) initializing existing logic (if any, otherwise random logic can be used), (iii) RL agents make a decision when required, by alternating between the existing heuristic logic and its own logic, (iv) RL agents store states, decisions, and associated rewards returned from environment, (v) RL agents'weights updated based on the rewards and RL-based critic's outputs, RL-critic weights updated based on rewards, and (vi) repeating steps (iii) to (v) until performance of RL agents convergences.

In an aspect, there is a component involving domain knowledge incorporation via progressive knowledge improvement. Example implementations can involve, (i) running the training alongside the python-based simulator for the first iteration, (ii) for the next iteration, replace the existing logic in the training component with the trained RL agent from the previous iteration and training a new set of multiple RL agents, and (iii) repeating steps (i) and (ii) until convergence.

In an aspect, there is a component involving a python-based simulator. Example implementations can involve (i) initializing the simulator environment with the user configuration and layout, (ii) generating initial states and expose states to RL agents, (iii) receiving a decision from the RL agent and transition to the next state based on user defined logic of the system, (iv) emitting a reward for RL agents based on the decision made, (v) repeating steps (ii) to (iv) until RL agents terminate.

### BRIEF DESCRIPTION OF DRAWINGS

FIG. 1 illustrates a multi-agent reinforcement learning system, in accordance with an example implementation.

FIG. 2 illustrates an example flow of the training process of the multi-agent reinforcement learning policies, in accordance with an example implementation.

FIG. 3 illustrates an example flow for applying the multiple RL agents after training for dynamic dispatching in material handling systems, in accordance with an example implementation.

FIG. 4 illustrates an example of the domain knowledge incorporation via progressive knowledge improvement, in accordance with an example implementation.

FIG. 5 illustrates an example of the simulator's architecture with multiple layers of abstraction, which allow for generalizability and reusability, in accordance with an example implementation.

FIG. 6 illustrates an example flow of the core logic of the simulator for material handling system, in accordance with an example implementation.

FIG. 7 illustrates an example materials handling system upon which example implementations can be applied.

FIG. 8 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

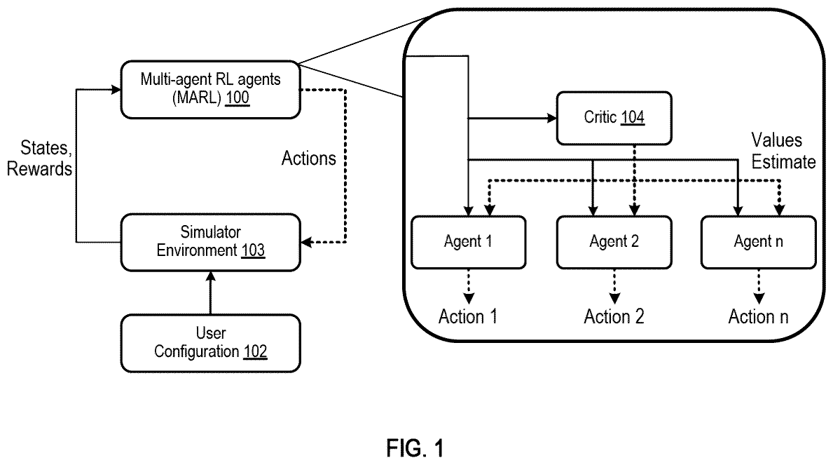

FIG. 1 illustrates a multi-agent reinforcement learning system, in accordance with an example implementation. In a first component 100, there is a training of event-based multi-agent RL with domain knowledge incorporation. The training of the multi-agent RL policies for dynamic dispatching begins at the first component with the initialization of n number of policies, where n represents the number of decision-making points in the conveyor system. These policies are typically parameterized and represented using neural networks. Furthermore, an additional critic, also represented by a neural network is also parameterized.

Additionally, any existing heuristic-based logic that is available should also be initialized with their respective hyperparameters. For example, experts may have determined that items may be dispatched to the closest subprocess with the constraint that no more than ten items should be dispatched to any subprocess.

Next, the environment simulator 103 is initialized with the respective parameters such that it reflects the actual system as closely as possible. Example parameters may include, but are not limited to, number of subprocess, location of subprocess, processing times, and so on, in accordance with the desired implementation, which can be set based on the desired user configuration 102.

With the simulator 103 and multi-agent policies ready, the training of the multi-agent RL policies can begin. The training process includes the simulator 103 exposing the current state of the simulated system. The state information is used as input by the multi-agent RL 100. Within the multi-agent RL block, the critic 104 takes the state as input and outputs a prediction of the value of the current state. Additionally, the n number of policies also takes the state information as input and outputs a dispatching decision if it is required. The simulator 103 takes the dispatching decision made by the n policies and transitions to the next state and returns a reward value that is defined by the user. The process of the policies interacting with the simulator 103 continues until the simulation ends. At the end of one simulation, the weights of the critic and weights of the policies based on the values estimates and rewards accumulated by the policies. The process described represents one training episode. Here, the state, action and reward are arbitrary values that are defined by the user, depending on the context of the application. An example of state information could be the number of items in queue at each subprocess, the type of each item and/or the number of items at each section of the system and more depending on the desired implementation. An example of the action may be the destination or direction of the items depending on the desired implementation. An example of the reward maybe the total throughput of the system, or the length of queue at each subprocess depending on the desired implementation.

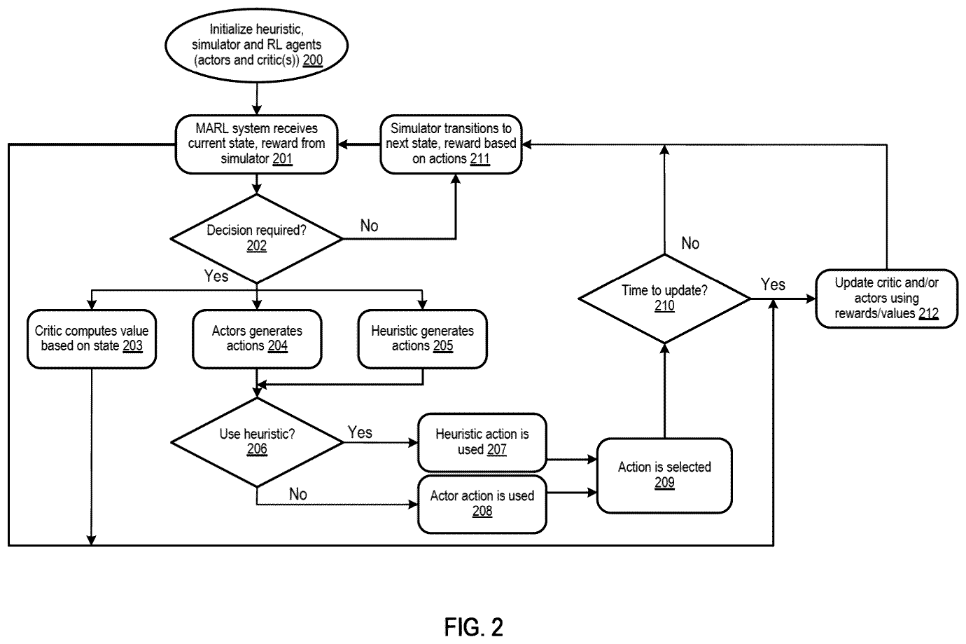

FIG. 2 illustrates an example flow of the training process of the multi-agent reinforcement learning policies, in accordance with an example implementation. To facilitate the learning process of the RL policies, the dispatching decision made by the heuristic-based logic is also occasionally used to replace the policies'dispatching decision, where the corresponding rewards made by the heuristic logic are then used to train and update the weights of the policies.

At 200, the flow begins with the initialization of all the necessary components, such as the heuristics as defined by the user, the simulator, and the RL agents including the actors and critic(s). The RL agents are representative of the decision points for the MARL based decision system. Once these components are initialized, the multi agent reinforcement learning (MARL) system is therefore created. At 201, the formed MARL system then receives the current state and the reward from the simulator. In example implementations described herein, the current state and the reward from the simulator are provided in an event-based manner rather than a time-based manner (e.g., for when a dispatching decision for a received package is required, or other decision on an example factory floor). Thus, not every time step of the simulator requires a decision. In an example, the simulator iterates to the next step until the decision is required (e.g., a package arrives at the incoming point). Thus, at 202, a determination is made as to whether a decision is required, and if not (No), then the flow proceeds to 211 wherein the simulator iterates to the next time step to obtain the next state or reward based on the outstanding actions (e.g., package continues to move along the conveyor belt).

If a decision is required (Yes), then there are three processes that can be executed. In a first process 204, the MARL network is utilized to generate the decision for the next action. In a second process 205, the user defined heuristic is executed to generate the action. Further, there can be a critic in a third process 203 which computes the value based on the state and informs the MARL of the current state, along with the estimated throughput or reward of the state.

Then at 206, a decision is made as to whether to use the heuristic action or the MARL action. The decision for the heuristic action can be set according to any desired implementation (e.g., a flag or condition indicating that the heuristic is to be used every other action or every third action, according to a schedule, etc.). If the condition is met (Yes) then the heuristic action is executed at 207. Otherwise (No), the action heuristic from the MARL is executed at 208.

Given the selected action to be executed, the action is executed at 209 for the simulator, which continues the simulation based on the execution of the action.

At 210, a determination is made as to whether it is time to update the neural networks of the MARL system. The time to update can be set in accordance with the desired implementation (e.g., after 100 different decisions). If it is to be updated (Yes), then the flow proceeds to 212 to update the MARL agents using the data collected by the simulator along with the critic value, and the rewards and values. The updating the MARL can be done in any way in accordance with the desired implementation. The reward is assigned based on each successful material dispatch for the each of the reinforcement learning agents from 211 to 201. Each time step of the simulator 211 in the simulation environment is iteratively executed until a convergence or a specified goal is reached. Convergence can be set in accordance with the desired threshold, or a specified goal can be user defined in accordance with the desired implementation (e.g., after 2000 iterations).

In example implementations described herein, the critic is utilized to estimate the value of the agent's decision, and what the next state will be once the agent decision is executed. In an example, when the MARL agent makes a decision to dispatch an object to a particular location, it will take time to reach the location, where the time the package will be received is not necessarily immediately known. In such an example, a delayed reward signal could be received which is then provided to update the critic, which could then learn to inform the MARL agent earlier as needed.

Through this flow in FIG. 2, the MARL system is trained for deployment, and can learn whether to keep the heuristic or purely depend on the MARL system agents for selecting the action.

In example implementations, the reinforcement learning agents can also be heterogenous for classes of decisions to be made and trained in parallel despite being heterogenous. For example, different apparatuses (e.g., conveyor belt, robot, etc.) will have different classes of decisions that need to be made. As an example, picking robots can have decisions of pickup, dispatch, place, whereas conveyor belt may have start and stop. Because the decisions and information regarding such decisions are heterogenous, the simulator data associated with such decisions and agents may also be heterogenous and therefore different in size. Thus, during training, such information may be truncated to have uniform or the same size during the training, so that the data provided to the reinforcement learning based decision system at each iteration so that data received by the reinforcement learning based decision system is of the same size. In this manner, even a heterogenous MARL system can be trained through the example implementations described herein.

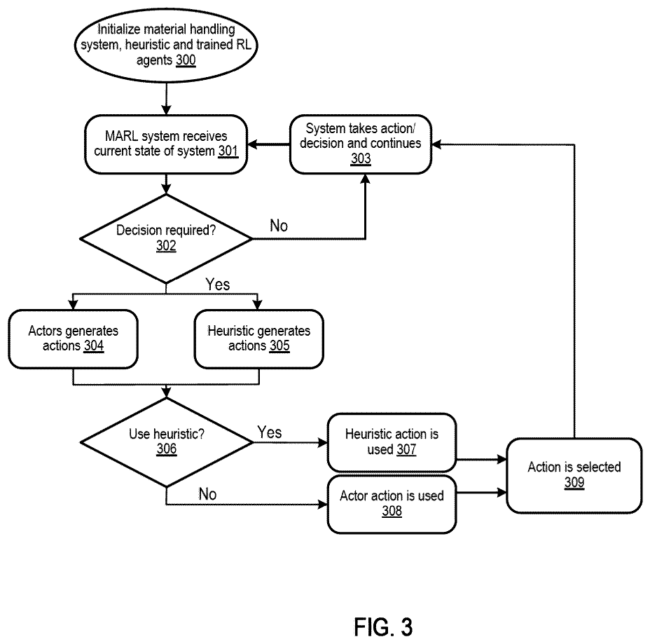

FIG. 3 illustrates an example flow for applying the multiple RL agents after training for dynamic dispatching in material handling systems, in accordance with an example implementation. After the training process of FIG. 2, the critic is thereby omitted and the agents do not need to be updated unless the user wishes for them to be updated. In this second component, there is domain knowledge incorporation via progressive knowledge improvement.

At 300, the material handling system is initialized, which involves initializing the heuristic and trained RL agents. At 301, the MARL system receives and observes the current state of the system and then determines if a decision is required at 302. If not (No), then the flow proceeds to 303 to allow the system to continue, otherwise (Yes) the flow proceeds to generate actions via the MARL system at 304 and by the user defined heuristics at 305.

At 306, a decision is made as to whether to use the action by the MARL system at 304 or by the heuristics. In example implementations, the user defined heuristics can still be maintained to facilitate the desired implementation, or the MARL agent decisions can be solely relied upon, or the decision selection can be performance based or user selected in accordance with the desired implementation. If the heuristic is used (Yes), then the process proceeds to 307 to use the heuristic action, otherwise (No) the MARL actor action is used at 308. At 309, the action is then selected and executed and the flow proceeds to 303 for the system to execute the action/decision.

The simulator can also be configured in accordance with the desired implementation, either at a high level, or at a lower level (e.g., layout, cycle time, location of each dispatch location, speed, and so on).

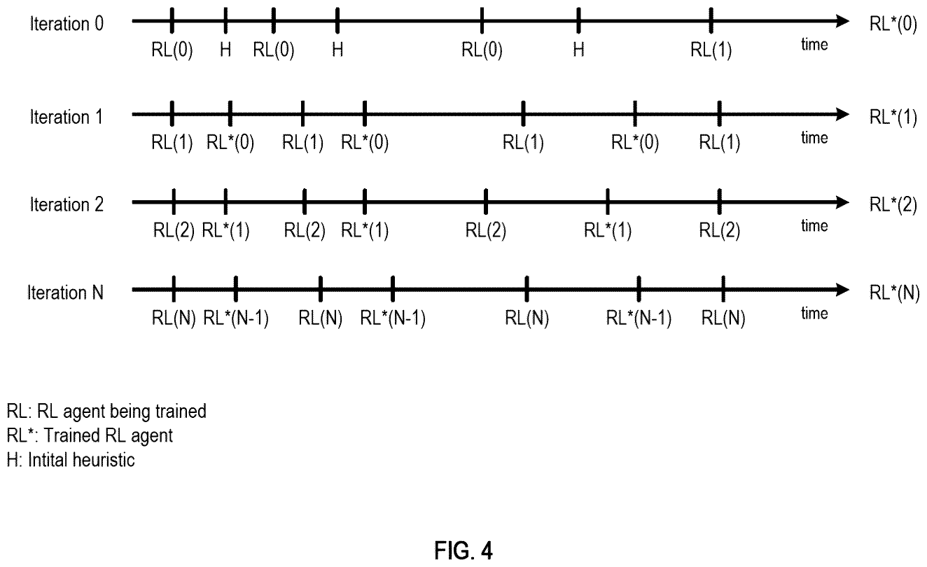

In example implementations, to improve the performance of the RL policies, the first iteration of RL policies is trained with the heuristic-based logic. In the second iteration, the heuristic is replaced with the trained RL policies from the first iteration and used to train the second iteration. The process is repeated for any arbitrary number of times until the performance stops improving or converges. FIG. 4 illustrates an example of the domain knowledge incorporation via progressive knowledge improvement, in accordance with an example implementation. Specifically, FIG. 4 illustrates an example of multiple iterations of training of the multiple RL agents. In the first iteration, domain knowledge is incorporated in the form of heuristics. In subsequent iterations, an improved version of the knowledge is used to guide the multiple RL agents by replacing the heuristic with RL agents from the previous iterations. After the RL policies have achieved a satisfactory performance, the RL policies can then be applied to make dynamic dispatching decisions on actual material handling system.

In a third component, there can be a Python-based material handling simulator, so that it can be easily interfaced with external Python packages and transparent while being generalizable and easily reusable for simulating material handling in other domains. The example implementations described herein also aim for it to be suitable as a platform to develop optimization algorithms, which often requires running many iterations, hence requiring it to be scalable as well as accurate.

To achieve the condition of easy interface and being transparent, example implementations described herein fully implement the simulator in native Python, without depending on any task-specific open source/commercial packages. This allows the simulator to be isolated from dependency issues and allows users to easily interface with external Python packages.

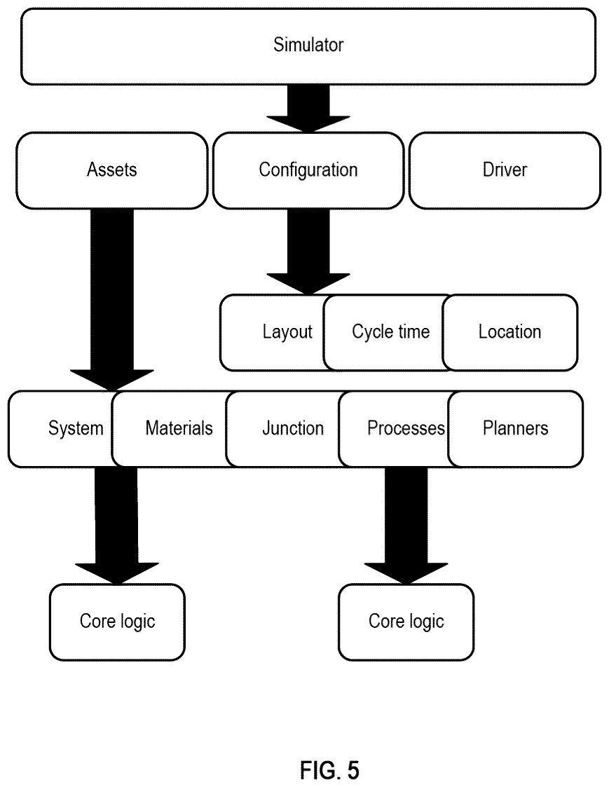

To achieve the goal of generalizability, the example implementations described herein involve multiple layers of abstraction in the design of the simulator, such that users could easily customize and re-use the simulator according to any arbitrary amount of modification. FIG. 5 illustrates an example of the simulator's architecture with having multiple layers of abstraction, which allow for generalizability and reusability, in accordance with an example implementation.

An example implementation of the abstraction is that from user application perspective, at the first level of abstraction, the simulator is restricted to a main code that runs the simulator, a configuration file that allows the user to quickly modify high level parameters of a material handling system (e.g., layout, processing time, number of processes, and so on) for a fixed logic, and an asset file which contains the core logic of the material handling system.

Should the user require a higher degree of modification beyond the high-level modifications, the user can modify the logics within the asset file. This is the next level of abstraction, where in the assets file, multiple commonly used software classes are defined, such as planning logic, materials, sensors, junctions, merges, timers, processes, paths, job queues, and so on. The design of the simulator at this level of abstraction allows the user to directly modify the properties of each component of the simulator or define a new component if needed.

Finally, the next level of abstraction of the simulator is the core logic of the simulator which simulates the transition of the entire material handling system from one time point to the next time point. Example implementations described herein involve a scheme of updating the state of the simulator by assigning each material in the simulation a unique identifier (ID) that is independent of the layout. During the simulation, the program iterates over every single material in reverse order of the direction of the flow of material and checks for collision with other materials and also checks for the arrival of the material at all defined processes. If the materials are found to be at any defined sub-process, the logic of the subprocesses will be executed, hence allowing for accurate simulation of the entire system.

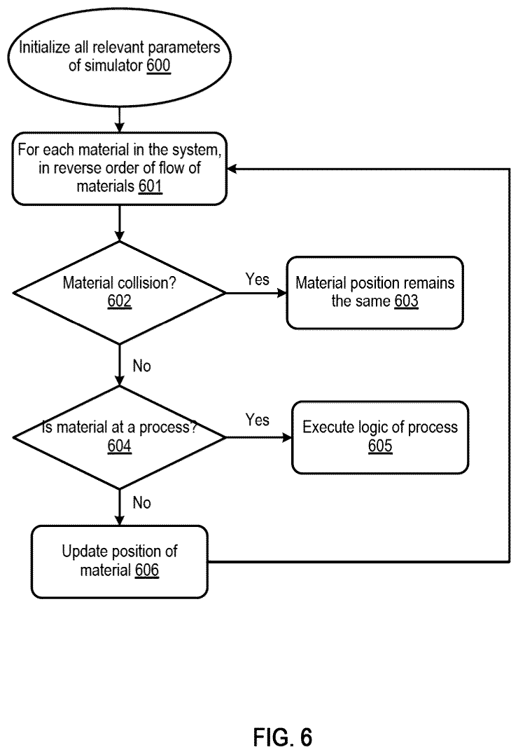

FIG. 6 illustrates an example flow of the core logic of the simulator for material handling system, in accordance with an example implementation. In the example of FIG. 6, the positions of every material are simulated and updated in reverse order of the flow of materials and each material is checked for collision with other materials and intersection with other processes at every step.

At 600, the simulator is initialized with all the user defined parameters as well as with parameters regarding the materials handling system environment. Such parameters can include decision points for dispatching materials, and attributes of the materials handling system (e.g., location of material pickup and drop off points, distances and routes between pickup and drop off points, weights of materials to be picked up, etc.).

At 601, the simulator is executed iteratively for each material in the system, in reverse order of the flow of materials. At 602, a determination is made as to whether there is a material collision. If so (Yes), then the material position is maintained as the same at 603. Otherwise (No), the flow proceeds to 604 to determine if the material is at a process. If so (Yes) the flow proceeds to 605 to execute the logic of the process otherwise (No) the position of the material is updated at 606.

Through the example implementations described herein, the multi-agent system can be used to discover a much more effective dynamic dispatching strategy than existing heuristics, which can increase overall throughputs of the system.

Further, the example implementations can facilitate a learning-based dispatching logic, which is more adaptable to uncertainties in the system in comparison to a static hand-design dispatching logic.

In addition, combining existing hand-design logic with a learning-based logic as described in the example implementations allows domain knowledge to be incorporated, while simultaneously improving and stabilizes the learning process of the multi-agent logic.

Finally, a modular and configurable Python-based simulator as utilized in the example implementations described herein allows the simulator to be easily adapted to other use cases and enable a much smoother interface with existing Python-based optimizers.

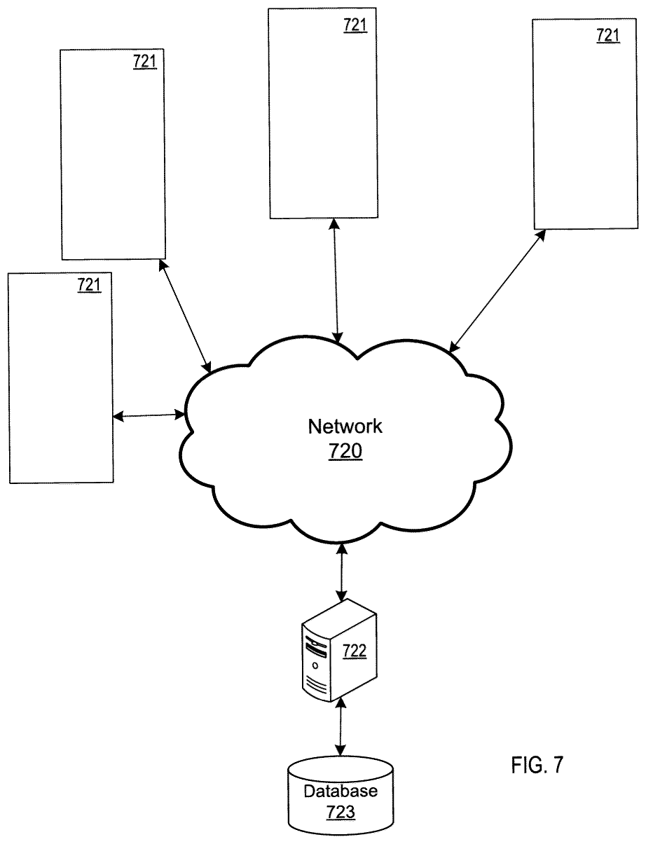

FIG. 7 illustrates an example materials handling system upon which example implementations can be applied. One or more materials dispatching apparatuses 721 involve physical machines (e.g., pickup robots, conveyor belts, vehicles, etc.) that are communicatively coupled to a network 720 (e.g., local area network (LAN), wide area network (WAN)) through the corresponding network interface of the sensor system installed in the materials dispatching apparatuses 721, which is connected to a management apparatus 722 configured to facilitate the functionality for conducting decision making for the materials dispatching apparatuses 721. The one or more materials dispatching apparatuses 721 may or may not be associated with sensors or other data collecting mechanisms, depending on the desired implementation. The management apparatus 722 manages a database 723, which contains historical data collected from the sensor systems or data collecting mechanisms from each of the materials dispatching apparatuses 721. In alternate example implementations, the data from the sensor systems of the materials dispatching apparatus 721 can be stored in a central repository or central database such as proprietary databases that intake data from the materials dispatching apparatuses 721, or systems such as enterprise resource planning systems, and the management apparatus 722 can access or retrieve the data from the central repository or central database. The sensor systems of the materials dispatching apparatuses 721 can include any type of sensors to facilitate the desired implementation and provide internal status machine data, such as but not limited to gyroscopes, accelerometers, global positioning satellite (GPS), thermometers, humidity gauges, or any sensors, and so on. As described herein, the management apparatus 722 can also be connected to one or more cameras (not illustrated) that are monitoring the external status of the materials dispatching apparatuses 721.

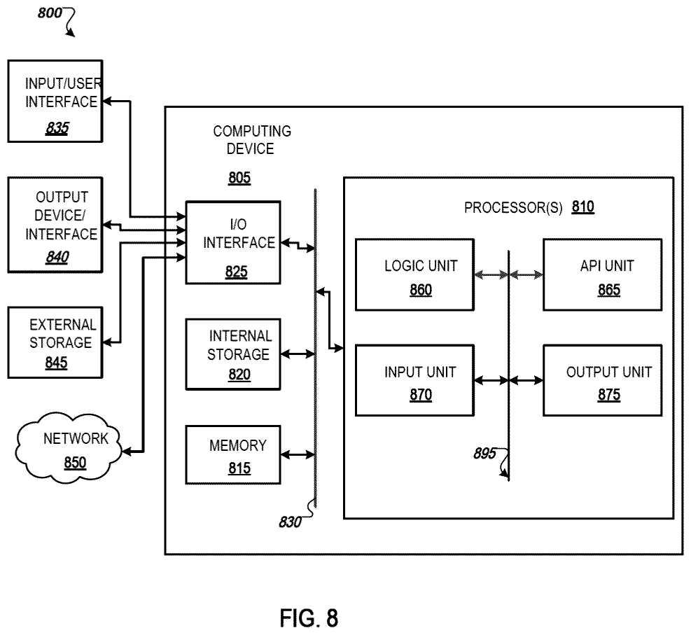

FIG. 8 illustrates an example computing environment with an example computer device suitable for use in some example implementations, such as the management apparatus 722 to facilitate the functionality of the materials handling system. Computer device 805 in computing environment 800 can include one or more processing units, cores, or processors 810, memory 815 (e.g., RAM, ROM, and/or the like), internal storage 820 (e.g., magnetic, optical, solid state storage, and/or organic), and/or I/O interface 825, any of which can be coupled on a communication mechanism or bus 830 for communicating information or embedded in the computer device 805. I/O interface 825 is also configured to receive images from cameras or provide images to projectors or displays, depending on the desired implementation.

Computer device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via I/O interface 825) to external storage 845 and network 850 for communicating with any number of networked components, devices, and systems, including one or more computer devices of the same or different configuration. Computer device 805 or any connected computer device can be functioning as, providing services of, or referred to as a server, client, thin server, general machine, special-purpose machine, or another label.

I/O interface 825 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computer device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or in a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, input unit 870, output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide output based on the calculations described in example implementations.

Processor(s) 810 can be configured to execute the method or instructions for implementation of a multi-agent reinforcement learning (MARL) based decision system for a materials handling system of FIG. 7, which can involve initializing a simulation environment involving decision points for dispatching materials and attributes of the materials handling system, the simulation environment configured to request a decision for materials dispatch at the decision points to the multi-agent reinforcement learning based decision system (e.g., as shown at 600 of FIG. 6); initializing the reinforcement learning agents representative of the decision points for the multi-agent reinforcement learning based decision system; initializing domain expert heuristics for the decision points for the multi-agent reinforcement learning based decision system (e.g., as shown at 200 of FIG. 2); and iteratively training the reinforcement learning based decision system with the initialized domain expert heuristics on the simulation environment as shown in FIG. 2. As described herein, because the initialization of the simulation environment involves decision points for dispatching materials and attributes of the materials handling system, and because the simulation environment is configured to request a decision for materials dispatch at decision points to the MARL based decision system, this allows for training of the MARL system to be conducted significantly faster than the implementations of the related art by avoiding the need for training at each time step.

Processor(s) 810 are configured to execute the method and instructions as described herein, wherein the iteratively training the reinforcement learning based decision system with the initialized domain expert heuristics on the simulation environment involves, for each time step in the simulation environment, receiving a current state and reward from the simulator (e.g., as shown at 201 of FIG. 2), the reward based on each successful material dispatch for the each of the reinforcement learning agents; and, for a decision point from the decision points being reached, selecting a decision for the decision point from the domain expert heuristics or from a decision generated by the reinforcement learning based decision system (e.g., as shown in 202-209 of FIG. 2); wherein the each time step in the simulation environment is iteratively executed until a convergence or a specified goal is reached as described in FIG. 2.

Processor(s) 810 are configured to execute the method and instructions as described herein, wherein the reinforcement learning based decision system is configured to select a decision from either the initialized domain expert heuristics (e.g., 207 as shown in FIG. 3) or from the trained decision heuristic (e.g., 208 as shown in FIG. 3).

Processor(s) 810 are configured to execute the method and instructions as described herein, wherein the simulation environment is configurable via adjustable parameters at multiple levels of the materials handling system as shown across the different levels of FIG. 5.

Processor(s) 810 are configured to execute the method and instructions as described herein, wherein the reinforcement learning agents are heterogenous for classes of decisions to be made, and wherein the reinforcement learning agents are trained in parallel as described in FIG. 3.

Processor(s) 810 are configured to execute the method and instructions as described herein, and further involve truncating data provided to the reinforcement learning based decision system at each iteration so that data received by the reinforcement learning based decision system is of a same size during the training as described in FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for implementation of a multi-agent reinforcement learning based decision
system for a materials handling system, the method comprising:
initializing a simulation environment comprising decision points for dispatching materials and attributes of the materials handling system, the simulation environment configured to request a decision for materials dispatch at the decision points to the multi-agent reinforcement learning based decision system;
initializing reinforcement learning agents representative of the decision points for the multi-agent reinforcement learning based decision system;
initializing domain expert heuristics for the decision points for the multi-agent reinforcement learning based decision system; and
iteratively training the reinforcement learning based decision system with the initialized domain expert heuristics on the simulation environment.

2. The method of claim 1, wherein the iteratively training the reinforcement learning based decision system with the initialized domain expert heuristics on the simulation environment comprises:
for each time step in the simulation environment:
receiving a current state and reward from the simulator, the reward based on each successful material dispatch for the each of the reinforcement learning agents; and
for a decision point from the decision points being reached, selecting a decision for the decision point from the domain expert heuristics or from a decision generated by the reinforcement learning based decision system;
wherein the each time step in the simulation environment is iteratively executed until a convergence or a specified goal is reached.

3. The method of claim 1, wherein the reinforcement learning based decision system is configured to select a decision from either the initialized domain expert heuristics or from the trained decision heuristic.

4. The method of claim 1, wherein the simulation environment is configurable via adjustable parameters at multiple levels of the materials handling system.

5. The method of claim 1, wherein the reinforcement learning agents are heterogenous for classes of decisions to be made, and wherein the reinforcement learning agents are trained in parallel.

6. The method of claim 5, further comprising truncating data provided to the reinforcement learning based decision system at each iteration so that data received by the reinforcement learning based decision system is of a same size during the training.

7. A non-transitory computer readable medium, storing instructions for implementation of a multi-agent reinforcement learning based decision system for a materials handling system, the instructions comprising:
initializing a simulation environment comprising decision points for dispatching materials and attributes of the materials handling system, the simulation environment configured to request a decision for materials dispatch at the decision points to the multi-agent reinforcement learning based decision system;
initializing reinforcement learning agents representative of the decision points for the multi-agent reinforcement learning based decision system;
initializing domain expert heuristics for the decision points for the multi-agent reinforcement learning based decision system; and
iteratively training the reinforcement learning based decision system with the initialized domain expert heuristics on the simulation environment.

8. The non-transitory computer readable medium of claim 7, wherein the iteratively training the reinforcement learning based decision system with the initialized domain expert heuristics on the simulation environment comprises:
for each time step in the simulation environment:
receiving a current state and reward from the simulator, the reward based on each successful material dispatch for the each of the reinforcement learning agents; and
for a decision point from the decision points being reached, selecting a decision for the decision point from the domain expert heuristics or from a decision generated by the reinforcement learning based decision system;
wherein the each time step in the simulation environment is iteratively executed until a convergence or a specified goal is reached.

9. The non-transitory computer readable medium of claim 7, wherein the reinforcement learning based decision system is configured to select a decision from either the initialized domain expert heuristics or from the trained decision heuristic.

10. The non-transitory computer readable medium of claim 7, wherein the simulation environment is configurable via adjustable parameters at multiple levels of the materials handling system.

11. The non-transitory computer readable medium of claim 7, wherein the reinforcement learning agents are heterogenous for classes of decisions to be made, and wherein the reinforcement learning agents are trained in parallel.

12. The non-transitory computer readable medium of claim 11, further comprising truncating data provided to the reinforcement learning based decision system at each iteration so that data received by the reinforcement learning based decision system is of a same size during the training.

13. An apparatus for implementation of a multi-agent reinforcement learning based decision
system for a materials handling system, the apparatus comprising:
a processor, configured to:
initialize a simulation environment comprising decision points for dispatching materials and attributes of the materials handling system, the simulation environment configured to request a decision for materials dispatch at the decision points to the multi-agent reinforcement learning based decision system;
initialize reinforcement learning agents representative of the decision points for the multi-agent reinforcement learning based decision system;
initialize domain expert heuristics for the decision points for the multi-agent reinforcement learning based decision system; and
iteratively train the reinforcement learning based decision system with the initialized domain expert heuristics on the simulation environment.

14. The apparatus of claim 13, wherein the processor is configured to iteratively train the reinforcement learning based decision system with the initialized domain expert heuristics on the simulation environment by:
for each time step in the simulation environment:
receiving a current state and reward from the simulator, the reward based on each successful material dispatch for the each of the reinforcement learning agents; and
for a decision point from the decision points being reached, selecting a decision for the decision point from the domain expert heuristics or from a decision generated by the reinforcement learning based decision system;
wherein the each time step in the simulation environment is iteratively executed until a convergence or a specified goal is reached.

15. The apparatus of claim 13, wherein the reinforcement learning based decision system is configured to select a decision from either the initialized domain expert heuristics or from the trained decision heuristic.

16. The apparatus of claim 13, wherein the simulation environment is configurable via adjustable parameters at multiple levels of the materials handling system.

17. The apparatus of claim 13, wherein the reinforcement learning agents are heterogenous for classes of decisions to be made, and wherein the reinforcement learning agents are trained in parallel.

18. The apparatus of claim 17, further comprising truncating data provided to the reinforcement learning based decision system at each iteration so that data received by the reinforcement learning based decision system is of a same size during the training.
